(19) United States
(12) Patent Application Publication
(10) Pub. No.: US 2025/0221414 A1
(43) Pub. Date: Jul. 10, 2025

(54) BACILLUS VELEZENSIS DRY SUSPENDING AGENT AND PREPARATION METHOD THEREOF

(71) Applicants: Plant Protection Research Inst. of Guangdong..., Guangzhou City (CN); Huizhou YinNong Technology Co., Ltd., Guangzhou City (CN); SOUTH CHINA UNIVERSITY OF TECHNOLOGY, Guangzhou City (CN); GUANGDONG BRANCH OF CHINA TOBACCO GEN. CO., LTD., Guangzhou City (CN)

(72) Inventors: Qiyun YANG, Guangzhou City (CN); Birun LIN, Guangzhou City (CN); Zhengming LIN, Guangzhou City (CN); Huifang SHEN, Guangzhou City (CN); Kui TAN, Huizhou City (CN); Junrui MO, Huizhou City (CN); Yixi QIAN, Huizhou City (CN); Lianan LIAO, Huizhou City (CN); Xiaohui WANG, Guangzhou City (CN); Zepeng CHEN, Guangzhou City (CN); Xiaoming PU, Guangzhou City (CN); Jingxin ZHANG, Guangzhou City (CN); Dayuan SUN, Guangzhou City (CN); Pingping LIU, Guangzhou City (CN); Wencai LI, Guangzhou City (CN)

(21) Appl. No.: 18/745,813

(22) Filed: Jun. 17, 2024

(30) Foreign Application Priority Data
Jan. 8, 2024 (CN) 20241002923.1

(51) Int. Cl. A01N 63/22; A01N 25/04; A01P 1/00; A01P 21/00

(52) U.S. Cl. CPC A01N 63/22; A01N 25/04; A01P 1/00; A01P 21/00

(57) ABSTRACT

The present disclosure belongs to the field of biotechnology. A Bacillus velezensis dry suspending agent is provided, which includes: bacterial cells collected after Bacillus velezensis is fermented and centrifuged, a wetting agent, a dispersing agent, a disintegrating agent, and a carrier. The wetting agent is an organic polymer sulfonate. The Bacillus velezensis dry suspending agent of the present disclosure has ideal wetting time, suspension rate, and spore content. Further, the dry suspending agent can maintain high spore survival rate in an environment of ultraviolet radiation. Moreover, a preparation method of a Bacillus velezensis dry suspending agent is further provided. The dry suspending agent can maintain high spore content under the conditions of selection and cooperation of suitable parameters.

### CROSS-REFERENCE TO RELATED APPLICATION

This application claims priority to CN Patent Application 202410029123.1 filed on Jan. 8, 2024, which is incorporated by reference herein in its entirety. The Bacillus velezensis BV-Y1 culture was deposited with the Guangdong Microbial Culture Collection Center (GDMCC) on Dec. 8, 2023 and has been assigned the registration number GDMCC NO: 64124.

### FIELD OF THE INVENTION

The present disclosure relates to the field of biotechnology, and specifically, to a Bacillus velezensis dry suspending agent and a preparation method thereof.

### BACKGROUND OF THE INVENTION

A dry suspending agent is a granular preparation prepared by mixing an active ingredient of a pesticide, a filler, and various additives through wet grinding and spray-drying granulation processes. Compared to conventional water dispersible granules, the dry suspending agent combines the advantages of both suspension concentrate (SC) and wettable powder (WP): high suspension stability and dispersibility; good wettability of particles in water and fast disintegration; high storage stability; low dust, environment-friendly characteristics, and high safety in application; and good particle flowability and low tendency to agglomeration. Therefore, the dry suspending agent helps to prolong the storage time of a biocontrol bacterium agent to improve the use efficiency of the bacterium agent and reduce environmental pollution.

Bacillus velezensis is a common biocontrol bacterium, which can effectively inhibit the growth of a variety of phytopathogens. Bacillus velezensis provides mineral nutrition elements, such as N, P, K, and Fe, for the growth of plants through metabolism, and synthesizes growth hormones for promoting the growth of the plants. Bacillus velezensis can induce the plants to produce systemic resistance, and compete with pathogenic bacteria when coexisting with the pathogenic bacteria to achieve an effect of bacteriostasis and disease prevention. There are some patent reports on Bacillus velezensis. For example, CN116042481A reports a Bacillus velezensis compound chitosan oligosaccharide fermentation inoculant, and CN116082470A reports a Bacillus velezensis antibacterial lipopeptide, and a preparation method and application thereof. Research on the development of Bacillus velezensis biocontrol preparations is limited. The main reason is that the development of microbial pesticide formulae and adjuvants faces severe challenges, and the formulae and adjuvants that have been successfully applied to chemical pesticides are difficult to apply to microbial preparations. Successful microbial products need to have stable shelf life (including stability after dilution), the best possible biological control effect (such as improving target positioning and residence time), and the ability to strongly resist the influence of external environmental factors. In China, only Bacillus velezensis (CGMCC No. 14384) water dispersible granules have been registered as a pesticide, and a dry suspending agent has not been registered and reported yet. Therefore, according to the characteristics of Bacillus velezensis and the requirements for microbial pesticides, the present patent develops a Bacillus velezensis dry suspending agent formula and adjuvants to prepare a green dry suspending agent.

### SUMMARY OF THE INVENTION

In order to solve the foregoing technical problem, the present disclosure provides a Bacillus velezensis dry suspending agent, which has ideal wetting time, suspension rate, and spore content. Further, the dry suspending agent can maintain high spore survival rate in an environment of ultraviolet radiation. Moreover, the present disclosure further provides a preparation method of a Bacillus velezensis dry suspending agent. The dry suspending agent can maintain high spore content under the conditions of selection and cooperation of suitable parameters.

Specifically, in an aspect, the present disclosure provides a Bacillus velezensis dry suspending agent, which includes: bacterial cells collected after Bacillus velezensis is fermented and centrifuged, a wetting agent, a dispersing agent, a disintegrating agent, and a carrier. The wetting agent is an organic polymer sulfonate.

In some embodiments, a mass percentage of the wetting agent is 2-5%.

In some embodiments, the wetting agent is selected from W610, Multiwet 8269, and SXC.

In some embodiments, the dispersing agent is selected from D863, SP-DF2225, NNO, and U3A.

In some embodiments, a mass percentage of the dispersing agent is 20-40%.

In some embodiments, the disintegrating agent is selected from urea, sodium sulfate, potassium sulfate, and ammonium sulfate.

In some embodiments, the disintegrating agent is sodium sulfate or potassium sulfate.

In some embodiments, a mass percentage of the disintegrating agent is 4-6%.

In some embodiments, the carrier is selected from calcined kaolin, light calcium carbonate, white carbon black, bentonite, and diatomite.

In some embodiments, the carrier is calcined kaolin.

In some embodiments, the Bacillus velezensis dry suspending agent further includes a protective agent.

In some embodiments, the protective agent is selected from sodium fluorescein, ascorbic acid, and cyclodextrin.

In some embodiments, the protective agent is sodium fluorescein.

In some embodiments, a usage amount of protective agent is 0.8-2%.

In some embodiments, a mass percentage of the bacterial cells collected after Bacillus velezensis is fermented and centrifuged is 3-10%.

In another aspect, the present disclosure provides a preparation method of a Bacillus velezensis dry suspending agent, which includes the following steps: mixing bacterial cells collected after Bacillus velezensis is fermented and centrifuged, a wetting agent, a dispersing agent, a disintegrating agent, a carrier, and a protective agent (if applicable) in a ratio, grinding, and spray-drying to prepare a Bacillus velezensis dry suspending agent. The grinding time is 1-3 h, the inlet air temperature of spray-drying is 110-130° C., an atomization frequency is 110-150 Hz, and a feeding speed is 5-15 rpm/min.

In some embodiments, the grinding time is 2 h, the atomization frequency is 150 Hz, the inlet air temperature is 120° C., and the feeding speed is 10 rpm/min.

In some embodiments, the grinding time is 2 h, the atomization frequency is 110 Hz, the inlet air temperature is 120° C., and the feeding speed is 10 rpm/min.

In some embodiments, the grinding time is 2 h, the atomization frequency is 120 Hz, the inlet air temperature is 120° C., and the feeding speed is 15 rpm/min.

In some embodiments, the grinding time is 2 h, the atomization frequency is 150 Hz, the inlet air temperature is 110° C., and the feeding speed is 15 rpm/min.

In some embodiments, the grinding time is 2 h, the atomization frequency is 150 Hz, the inlet air temperature is 130° C., and the feeding speed is 10 rpm/min.

### Description of Terms

Certain implementations of the present disclosure will be described in detail below. The present disclosure is intended to cover all substitutions, modifications, and equivalent technical solutions, which are included within the scope of the present disclosure as defined by the claims. Those skilled in the art will recognize that many methods and materials similar or equivalent to those described herein can be used in the practice of the present disclosure. The present disclosure is in no way limited to the methods and materials described herein. In the case that one or more incorporated documents, patents, and similar materials differ from or conflict with the present disclosure (including, but not limited to, defined terms, term applications, described techniques, and the like), the present disclosure shall prevail.

It is further to be recognized that for purposes of clarity, certain features of the present disclosure have been described in multiple separate implementations, and they may also be provided as a combination in a single embodiment. On the contrary, for purpose of concision, various features of the present disclosure have been described in a single implementation, and they may also be provided separately or provided as any suitable sub-combination.

Unless otherwise specified, all scientific and technical terms used in the present disclosure have the same meaning as commonly understood by those skilled in the art to which the present disclosure belongs. All patents and publications related to the present disclosure are incorporated by reference in their entirety.

In this description, the reference term “an embodiment”, “some embodiments”, “example”, “specific example” or “some examples” means that a specific feature, structure, material or characteristic described with reference to the embodiment or example is included in at least one embodiment or example of the present disclosure. In this description, the schematic representations of the foregoing terms are not necessarily directed to the same embodiment or example. Furthermore, the described specific feature, structure, material or characteristic may be combined in an appropriate way in any one or more embodiments or examples. In addition, those skilled in the art may combine different embodiments or examples, as well as features of different embodiments or examples described in this description unless they are inconsistent with each other.

The term “wt %” represents a weight percentage or mass percentage.

In the following content, all numbers disclosed herein are approximate values, regardless of whether the word “about” or “approximately” is used. The value of each number may vary by 1%, 2%, 5%, 7%, 8%, 10%, 15% or 20%. Whenever a number with N value is disclosed, any number with N+/−1%, N+/−2%, N+/−3%, N+/−5%, N+/−7%, N+/−8%, N+/−10%, N+/−15% or N+/−20% values are clearly disclosed. “+/−” means plus or minus.

### DETAILED DESCRIPTION OF THE EMBODIMENTS

In order to make the objectives, the technical solutions, and the advantages of the present disclosure clearer, the present disclosure will be further described in detail below with reference to embodiments. Specific embodiments described herein are merely used for explaining the present disclosure, and are not intended to form any limitation to the present disclosure. In addition, in the following description, descriptions of well-known structures and techniques are omitted to avoid unnecessarily obscuring the concepts of the present disclosure. These techniques have also been described in many publications.

All reagents used in the present disclosure are commercially available or prepared by methods described in the present disclosure.

### Test Materials and Instruments

Test bacterial strain: bacterial cells collected after Bacillus velezensis is fermented and centrifuged, with a bacteria content of 3×10¹¹ CFU/mL, provided by Plant Protection Research Institute, Guangdong Academy of Agricultural Sciences.

Test carriers: calcined kaolin, light calcium carbonate, white carbon black, bentonite, and diatomite.

Test wetting agents (substances that enable solid pesticides insoluble or not wetted by water to be wetted by water): succinate (Multiwet 8269) (sodium dioctyl sulfosuccinate, CRODA (China) company), sulfonate (SXC) (glycine benzyl ester sodium p-toluenesulfonate, Japan Takemoto Oil & Fat Co., Ltd.), and organic polymer sulfonate (W610) (calcium dodecyl benzene sulfonate, DOW Chemical China Company Limited).

Test dispersing agents (substances that enable pesticides to be uniformly dispersed in water): calcium lignosulfonate (D863) (Shenzhen Zhongshenghe Biotechnology Co., Ltd.), naphthalenesulfonate (SP-DF2225, Jiangsu SinvoChem S&T Co., Ltd., and NNO, Shanghai Macropolymer Materials Co., Ltd.), sodium lignosulfonate (U3A) (sodium lignosulfonate, Nanjing Jierun Technology Co., Ltd.).

Test disintegrating agents: urea, anhydrous sodium sulfate, ammonium sulfate, and K₂SO₄.

Test protective agents: sodium fluorescein, ascorbic acid, and cyclodextrin.

### Experimental Methods

Various indexes of a dry suspending agent are respectively determined according to China's relevant national standards. The wetting time is measured by the graduated cylinder experiment method (GB/T 5451-2001), the bacteria content and the suspension rate are measured by the plate colony counting method according to China's national standard GB/T 14825-2006 and enterprise standard (HG/T 2467.13-2003).
1. Wetting time: according to the standard GB/T5451-2001, 100±1 mL of standard hard water is placed into a 250 ml beaker, the beaker is placed into a thermostatic water bath at 25±1° C., and the liquid level is made flush with the water level of the water bath. After the hard water is heated to 25±1° C., 5±0.1 g of test sample (the test sample needs to be representative uniform powder without caking or agglomeration) is weighed and placed onto a watch glass, the test sample is completely uniformly poured onto the liquid level of the beaker at one time from a position flush with the mouth of the beaker without disturbing the liquid level excessively. When the test sample is added, a stopwatch is started immediately for recording time until the test sample (a find powder film remaining on the liquid level may be ignored) is completely wetted. The wetting time (accurate to seconds) is recorded. The test is repeated five times, and a mean value is taken as the wetting time of the sample.
2. Spore content:
a. Sampling and sample preparation: 1 g (accurate to 0.1 g) of to-be-tested sample is weighed and placed into a triangular flask containing 99 mL of water, the mixture is uniformly shaken by an oscillator or by adding glass beads so that the bacteria solution is uniformly distributed. 1 mL of bacteria solution is sucked from the triangular flask with a graduated pipette and placed into a test tube containing 9 mL of water or a triangular flask containing 99 mL of water, and the mixture is uniformly shaken (to expand the dilution factor) for later use.
b. Slide preparation: a small amount of bacteria solution is sucked from the uniformly shaken bacteria solution with a pipette, and injected into a 25×16 blood counting chamber from one end of a cover slip to make the bacteria solution penetrate along a gap between cover slips, the excess bacteria solution overflowing from the tank is absorbed with filter paper. During the operation, attention should be paid not to create bubbles between the counting plate and the cover slip, otherwise the operation will be repeated to prepare a slide for later test.
c. Detection and counting: the prepared slide is placed under an optical microscope with a 400× magnification factor, spores in four large grids at four corners and the large grid in the middle (a total of 80 small grids) are counted.

$$A = B \times C \times 4 \times {10}^{6} \qquad ( 1 )$$

A: the total count of spores in 1 g of to-be-tested sample (10⁸ CFU/g)
B: the mean count of spores per small grid;
C: dilution factor;
4×10⁶: constant of 1 mL of volume in each small grid of the blood counting plate.
3. Suspension rate: it is measured according to China's national standard GB/T 14825-2006. About 1.0 g of test sample is weighed and placed into a 200 mL beaker containing 50 mL of standard hard water at 30±2° C., the beaker is swung by the hand in a circular motion at a rate of about 120 circles/minute for 2 min, the solution is placed into a water bath at the same temperature for 4 min, completely washed into a 250 mL graduated cylinder with standard hard water at 30±2°° C., and diluted to a graduation, and the graduated cylinder is covered with a plug, and turned upside down 30 times within 1 minute by taking the bottom of the graduated cylinder as the axis. The plug is opened, the graduated cylinder is vertically placed into a shock-free thermostatic water bath for 30 min without direct sunlight, 9/10 (namely, 225 mL) of the suspension in the graduated cylinder is removed by a pipette within 10-15 s without shaking or stirring up sediment in the graduated cylinder, and the tip of the pipette is always ensured to be a few millimeters below the liquid level. 25 mL of suspension at the bottom of the graduated cylinder is transferred to a petri dish, and dried for measurement, and the mass of the residue is weighed. A measured suspension rate is shown in Table 1.

TABLE 1
Suspension rate

| | |
|---|---|
| Sample mass/g | 0.9635 |

| | | |
|---|---|---|
| Petri dish constant | \textcircled{1} 112.7591 | \textcircled{2} 112.7593 |
| weight/g | | |
| Petri dish + | \textcircled{1} 112.8560 | \textcircled{2} 112.8560 |
| residue/g | | |

| | |
|---|---|
| Residue mass/g | 0.0967 |
| Calculation | 96.31 |
| result/% | |

4. Particle size distribution: it is measured according to the method described in China's national standard NY/T 1860.32-2016 Guidelines on the determination of physico-chemical properties of pesticides: Particle size distribution. Instrument or device: ZC457 Malvern Laser particle size distributor. 0.5 g of sample is placed into a 100 ml beaker, 50 mL of ultrapure water is added, the mixture is thoroughly stirred with a glass rod, and loaded onto a machine for test, the test is repeated three times, and a mean value is taken a result.
5. Ultraviolet stability: 1 g of preparation sample is weighed, diluted in sterile water, coated onto an LB plate, and subjected to ultraviolet radiation at a distance of 40 cm from a UV lamp (254 nm, 38 W) for 6 h and 12 h, respectively, and the spore content and spore survival rate are calculated.

### Preparation Example 1

5 wt % of bacterial cells collected after Bacillus velezensis was fermented and centrifuged, 2 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent. Results are shown in Table 2.

TABLE 2

| | | | | Spore content after | Spore survival rate |
|---|---|---|---|---|---|
| | After | After | Initial spore | 12 h of ultraviolet | after 12 h of |
| Preparation | grinding | drying | content/10¹⁰ | treatment/10¹⁰ | ultraviolet |
| Example | D98/μm | D98/μm | CFU/g | CFU/g | treatment/% |
| 1 | 5.82 ± 0.19 | 6.01 ± 0.06 | 2.7 ± 0.2 | 2.9 ± 0.2 | 110.0 ± 7.4 |

### Preparation Example 2

5 wt % of bacterial cells collected after Bacillus velezensis was fermented and centrifuged, 2 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 110 Hz, the inlet air temperature was 120° C., and a feeding speed was 10 rpm/min to prepare a dry suspending agent. The spore content was 2.7×10¹⁰ CFU/g.

### Preparation Example 3

5 wt % of bacterial cells collected after Bacillus velezensis was fermented and centrifuged, 2 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 120 Hz, the inlet air temperature was 120° C., and a feeding speed was 15 rpm/min to prepare a dry suspending agent. The spore content was 2.5×10¹⁰ CFU/g.

### Preparation Example 4

5 wt % of bacterial cells collected after Bacillus velezensis was fermented and centrifuged, 2 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 110° C., and a feeding speed was 15 rpm/min to prepare a dry suspending agent. The spore content was 2.6×10¹⁰ CFU/g.

### Preparation Example 5

5 wt % of bacterial cells collected after Bacillus velezensis was fermented and centrifuged, 2 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 130° C., and a feeding speed was 10 rpm/min to prepare a dry suspending agent. The spore content was 2.7×10¹⁰ CFU/g.

### Preparation Example 6

5 wt % of bacterial cells collected after Bacillus velezensis was fermented and centrifuged, 2 wt % of wetting agent W610, 30 wt % of dispersing agent U3A, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent. The spore content was 2.7×10¹⁰ CFU/g.

### Preparation Example 7

5 wt % of bacterial cells collected after Bacillus velezensis was fermented and centrifuged, 3 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120°° C., and a feeding speed was 10 rpm/min to prepare a dry suspending agent. The spore content was 3.4×10¹⁰ CFU/g.

### Preparation Example 8

5 wt % of bacterial cells collected after Bacillus velezensis was fermented and centrifuged, 4 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent. The spore content was 2.5×10¹⁰ CFU/g.

### Preparation Example 9

5 wt % of bacterial cells collected after Bacillus velezensis was fermented and centrifuged, 5 wt % of wetting agent W610, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent. The spore content was 2.7×10¹⁰ CFU/g.

### Preparation Example 10

5 wt % of bacterial cells collected after Bacillus velezensis was fermented and centrifuged, 2 wt % of wetting agent W610, 20 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent. The spore content was 2.4×10¹⁰ CFU/g.

### Preparation Example 11

5 wt % of bacterial cells collected after Bacillus velezensis was fermented and centrifuged, 2 wt % of wetting agent W610, 40 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent. The spore content was 3.2×10¹⁰ CFU/g.

### Comparison Example 1

5 wt % of bacterial cells collected after Bacillus velezensis was fermented and centrifuged, 2 wt % of wetting agent SXC, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent D1.

5 wt % of bacterial cells collected after Bacillus velezensis was fermented and centrifuged, 2 wt % of wetting agent Multiwet 8269, 30 wt % of dispersing agent D863, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent D2.

The spore content of the dry suspending agent D1 prepared by taking SXC as the wetting agent was the highest. However, the suspension rate of D1 was 48.7% only, and the wetting time was as long as 115 s. The suspension rate of the dry suspending agent D2 prepared by taking Multiwet 8269 as the wetting agent was 91.8%, which was the highest. However, the spore content of D2 was low. The spore content of the dry suspending agent of Preparation Example 1 that was prepared by taking W610 as the wetting agent was ideal, the suspension rate reached 90.0%, and the wetting time was 50 s only. It achieved two effects at the same time.

### Comparison Example 2

5 wt % of bacterial cells collected after Bacillus velezensis was fermented and centrifuged, 2 wt % of wetting agent W610, 30 wt % of dispersing agent SP-DF2225, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent D3.

5 wt % of bacterial cells collected after Bacillus velezensis was fermented and centrifuged, 2 wt % of wetting agent W610, 30 wt % of dispersing agent NNO, 5 wt % of disintegrating agent K₂SO₄, and 1 wt % of sodium fluorescein were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent D4.

The spore content of the dry suspending agent D3 prepared by taking SP-DF2225 as the dispersing agent was 0.9×10¹⁰ CFU/g only, the suspension rate was 73.3%, and the wetting time was as long as 224 s. The spore content of the dry suspending agent D4 prepared by taking NNO as the dispersing agent was 0.7×10¹⁰ CFU/g only, the suspension rate was 78.0%, and the wetting time was as long as 177 s. The spore content of the dry suspending agent of Preparation Example 1 that was prepared by taking D-863 as the dispersing agent or the dry suspending agent of Preparation Example 6 that was prepared by taking U3A as the dispersing agent was ideal, and the suspension rate reached over 90.0%.

### Comparison Example 3

5 wt % of bacterial cells collected after Bacillus velezensis was fermented and centrifuged, 2 wt % of wetting agent W610, 30 wt % of dispersing agent D863, 5 wt % of disintegrating agent K₂SO₄, and 1 wt % of cyclodextrin were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent D5.

5 wt % of bacterial cells collected after Bacillus velezensis was fermented and centrifuged, 2 wt % of wetting agent W610, 30 wt % of dispersing agent D863, and 5 wt % of disintegrating agent K₂SO₄ were mixed, calcined kaolin was added until 100%, and after being ground for 2 h, the mixture was spray-dried under the conditions that an atomization frequency was 150 Hz, the inlet air temperature was 120° C., and a feeding speed was 10 rpm/min to prepare a dry suspending agent D6.

After 12 h of ultraviolet treatment, the spore survival rate of the dry suspending agent D5 prepared by taking cyclodextrin as the protective agent or the dry suspending agent D6 without the protective agent was less than 75%, the survival rate of D5 was 72.6%, and the survival rate of D6 was 62.8% only.

The method of the present disclosure has been described with reference to preferred embodiments. Those of ordinary skill in the art can obviously make modifications or appropriate changes and combinations to the method and applications described herein within the content, spirit and scope of the present disclosure to implement and apply the technology of the present disclosure. Those skilled in the art can appropriately modify the parameters of the process with reference to the content to implement the present disclosure. It should be noted that all similar substitutions and modifications are obvious to those skilled in the art, and they are deemed to be included in the present disclosure.

1. A Bacillus velezensis dry suspending agent, comprising: bacterial cells collected after Bacillus velezensis is fermented and centrifuged, a wetting agent, a dispersing agent, a disintegrating agent, and a carrier, wherein the wetting agent is selected from W610, Multiwet 8269, and SXC, and preferably, a mass percentage of the wetting agent is 2-5%.

2. The Bacillus velezensis dry suspending agent according to claim 1, wherein the wetting agent is one or more of W610, Multiwet 8269, and SXC.

3. The Bacillus velezensis dry suspending agent according to claim 1, wherein the dispersing agent is D863, SP-DF2225, NNO or U3A, and preferably, a mass percentage of the dispersing agent is 20-40%.

4. The Bacillus velezensis dry suspending agent according to claim 1, wherein the disintegrating agent is selected from urea, sodium sulfate, potassium sulfate, and ammonium sulfate, preferably, the disintegrating agent is sodium sulfate or potassium sulfate, and preferably, a mass percentage of the disintegrating agent is 4-6%.

5. The Bacillus velezensis dry suspending agent according to claim 1, wherein the carrier is selected from calcined kaolin, light calcium carbonate, white carbon black, bentonite, and diatomite, and preferably, the carrier is calcined kaolin.

6. The Bacillus velezensis dry suspending agent according to any one of claims 1 to 5, further comprising: a protective agent, wherein the protective agent is selected from sodium fluorescein, ascorbic acid, and cyclodextrin, preferably, the protective agent is sodium fluorescein, and preferably, a usage amount of protective agent is 0.8-2%.

7. The Bacillus velezensis dry suspending agent according to any one of claims 1 to 5, wherein a mass percentage of the bacterial cells collected after Bacillus velezensis is fermented and centrifuged is 3-10%.

8. A preparation method of the Bacillus velezensis dry suspending agent according to any one of claims 1 to 7, comprising the following steps: mixing bacterial cells collected after Bacillus velezensis is fermented and centrifuged, a wetting agent, a dispersing agent, a disintegrating agent, a carrier, and a protective agent (if applicable) in a ratio, grinding, and spray-drying to prepare a Bacillus velezensis dry suspending agent, wherein the grinding time is 1-3 h, the inlet air temperature of spray-drying is 110-130° C., an atomization frequency is 110-150 Hz, and a feeding speed is 5-15 rpm/min.

9. The method according to claim 8, wherein
the grinding time is 2 h, the atomization frequency is 150 Hz, the inlet air temperature is 120° C., and the feeding speed is 10 rpm/min; or
the grinding time is 2 h, the atomization frequency is 110 Hz, the inlet air temperature is 120° C., and the feeding speed is 10 rpm/min; or
the grinding time is 2 h, the atomization frequency is 120 Hz, the inlet air temperature is 120° C., and the feeding speed is 15 rpm/min; or
the grinding time is 2 h, the atomization frequency is 150 Hz, the inlet air temperature is 110° C., and the feeding speed is 15 rpm/min; or
the grinding time is 2 h, the atomization frequency is 150 Hz, the inlet air temperature is 130° C. and the feeding speed is 10 rpm/min.
